(19) United States
(12) Patent Application Publication
(10) Pub. No.: US 2010/0151375 A1
(43) Pub. Date: Jun. 17, 2010

(54) TONER PRODUCT AND IMAGE FORMING METHOD

(75) Inventors: Tomomi OSHIBA, Tokyo (JP); Yasuko UCHINO, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 12/630,905

(22) Filed: Dec. 4, 2009

(30) Foreign Application Priority Data
Dec. 11, 2008 (JP) 2008315284

(51) Int. Cl. G03G 13/20; G03G 9/08

(52) U.S. Cl. 430/108.4; 430/124.1

(57) ABSTRACT

An objective is to provide a toner product with which the difference between the water content of a toner in a toner container and the water content of another toner present in an image forming apparatus is minimized, and a sharp charging amount distribution can be obtained to form high-quality images; and also to provide an image forming method thereof. Also disclosed is a toner product in which a toner is stored in a toner container, wherein the toner possesses a toner particle having an amount of a carboxyl group present on a surface of the toner particle, being 1.0×10⁻⁷-2.5×10⁻⁵ mol/g, and the toner container is made of a resin containing polyethylene terephthalate, the amount of the carboxyl group determined via titration employing a strongly basic solution as a titration reagent after dispersing the toner in water.

This application claims priority from Japanese Patent Application No. 2008-315284 filed on Dec. 11, 2008, which is incorporated hereinto by reference.

### TECHNICAL FIELD

The present invention relates to a toner product, and to an image forming method employing the toner product.

### BACKGROUND

In recent years, use of an emulsion association type toner through which a toner in small diameter exhibiting a sharp particle size distribution can be manufactured has increased with a demand of high-quality images when forming images by an image forming method in an electrophotographic system. The emulsion association type toner possesses a polar group on the surface of the toner particle or inside the toner particle from the viewpoint of manufacturing processes thereof. It is known that the polar group having adjusted the amount of it is effective to control toner electrification and dispersibility of colorants (refer to Patent Document 1). Further, a toner comprising a toner particle containing a polar group exhibits a large difference in water content between at high humility environment and at low humility environment, whereby the toner electrification is largely influenced by ambient environment.

Generally, a material exhibiting low moisture permeability is used for a toner container to store toner. And, a toner product composed of a toner and a toner container to store the toner is generally placed near an image forming apparatus, that is, at the same environmental condition as that of the image forming apparatus from the viewpoint of workability of replacing the toner product. However, when the toner product employing the toner container made of a material exhibiting low moisture permeability is installed in the image forming apparatus to form images, a toner in the toner container tends to be outside the condition of water content desired for another toner in the image forming apparatus, since the environment in the toner container is different from the environment in the image forming apparatus. In this case, a charging amount distribution of replenished toner in the image forming apparatus becomes broad, resulting in appearance of a problem such that defects are produced in the resulting image.

A toner container made of a resin, in which polyethylene terephthalate usable as a recycled material is contained, is disclosed in Patent Documents 2-4, but such the problem described above has not yet been solved.

(Patent Document 1) Japanese Patent O.P.I. Publication No. 2008-26887

(Patent Document 2) Japanese Patent O.P.I. Publication No. 10-83112

(Patent Document 3) Japanese Patent O.P.I. Publication No. 2003-35989

(Patent Document 4) Japanese Patent O.P.I. Publication No. 2007-206390

### SUMMARY

The present invention has been made on the basis of the above-described situation, and it is an object of the present invention to provide a toner product with which the difference between the water content of a toner in a toner container and the water content of another toner present in an image forming apparatus is minimized, and a sharp charging amount distribution can be obtained to form high-quality images; and also to provide an image forming method thereof.

### BRIEF DESCRIPTION OF THE DRAWING

FIG. 1 is a schematic illustration diagram showing an example of a toner container employed for a toner product of the present invention.

### DESCRIPTION OF THE PREFERRED EMBODIMENTS

It is a feature to provide a toner product of the present invention in which a toner is stored in a toner container, wherein the toner comprises a toner particle having an amount of a carboxyl group present on a surface of the toner particle, being 1.0×10⁻⁷-2.5×10⁻⁵ mol/g, and the toner container comprises a resin comprising polyethylene terephthalate, the amount of the carboxyl group determined via titration employing a strongly basic solution as a titration reagent after dispersing the toner in water. Further, in the toner product of the present invention, the above-described resin preferably has a polyethylene terephthalate content of 50% by weight or more.

It is another feature to preferably provide the toner product of the present invention, wherein the toner container has a wall thickness of 0.15-2.0 mm.

It is further another feature to provide an image forming method comprising the steps of charging an image carrier to provide an evenly charged potential on the image carrier; exposing the image carrier to light to form an electrostatic latent image on the image carrier with the evenly charged potential; developing the electrostatic latent image with a toner replenished from the above-described toner product to visualize a toner image; transferring the toner image onto a transfer material; and fixing the toner image on the transfer material.

### DETAILED DESCRIPTION OF THE INVENTION

Next, the present invention will be specifically described.

### [Toner Product]

Generally, a toner product comprises a toner and a toner container to store the toner, and the toner product of the present invention is a toner product in which a toner comprising a toner particle having an amount of a carboxyl group present on a surface of the toner particle, being 1.0×10⁻⁷-2.5×10⁻⁵ mol/g is stored in a toner container made of a resin containing at least polyethylene terephthalate (hereinafter, also referred to simply as “PET”).

### [Toner Container]

The toner container included in a toner product of the present invention is made of a resin consisting of PET, or a resin obtained by mixing PET and a resin material in combination. Examples of the resin material used with PET in combination include an olefin based resin such as polyethylene, polypropylene or the like, polycarbonate, polystyrene and so forth. In addition, a plasticizer, a compatibilizing agent, a modifier and so forth may be added therein, if desired. PET is desired to be recycled PET obtained by recycling a product collected from the market, an industrial waste material or the like.

The resin constituting the toner container preferably has a PET content of at least 50% by weight, more preferably has a PET content of at least 80% by weight, and most preferably has a PET content of 100% by weight. When the resin constituting the toner container has a PET content of at least 50% by weight, the toner container is possible to be designed to exhibit suitable moisture permeability. On the other hand, when the resin constituting the toner container has a small PET content, the toner container tends not to exhibit suitable moisture permeability.

When the toner container tends not to exhibit suitable moisture permeability, the following problems are produced.

(1) When replenishing a toner having a relatively small water content in comparison to another toner present in the image forming apparatus, a toner having a relatively high charging amount in comparison to another toner present in the image forming apparatus is replenished, whereby density of the resulting image tends to be lowered.

(2) When replenishing a toner having a relatively large water content in comparison to another toner present in the image forming apparatus, a toner having a relatively low charging amount in comparison to another toner present in the image forming apparatus is replenished, whereby fog tends to be generated in the resulting image.

PET contained in a resin constituting a toner container has a number average molecular weight (Mn) of 10000-50000, and also has a weight average molecular weight (Mw) of 25000-180000, as a molecular weight measured by gel permeation chromatography (GPC).

Molecular weights are measured via GPC employing the following conditions.

### (1) Pretreatment

In 2 mg of a mixed solvent having a 1:1 content ratio of HFIP (hexafluoroisopropanol) and chloroform, dissolved is 1.5 mg of a sample, and the resulting mixture is diluted by adding chloroform to make 3 mL. This is filtrated with hydrophilic PTFE of 0.45 (membrane filter cartridge, produced by Nihon Millipore K.K.) to measure the filtrate.

### (2) Measuring Condition

Column: Plge 15 μm MIXD-D 7.5×600 mm

Mobile phase: chloroform

Flow rate: 1.0 mL/min

Detection: 254 nm•injection amount: 5 μL

Molecular weight correction: monodisperse polystyrene; PS-1 (produced by Polymer Laboratories Ltd.)

Measuring apparatus: 515 pump, 717 plus automatic injection apparatus, and 486 ultraviolet-visible detector (manufactured by Nihon waters K.K.)

The toner container preferably has a wall thickness of 0.15-2.0 mm, and more preferably has a wall thickness of 0.2-1.35 mm. In the case of a toner container having a wall thickness exceeding 2.0 mm, the toner container tends not to exhibit suitable moisture permeability. On the other hand, in the case of a toner container having a wall thickness of less than 0.15 mm, desired strength tends not to be secured, and further, a problem tends to be produced in coagulation resistance when using in combination, a toner having a large amount of a carboxyl group present on the surface of a toner particle.

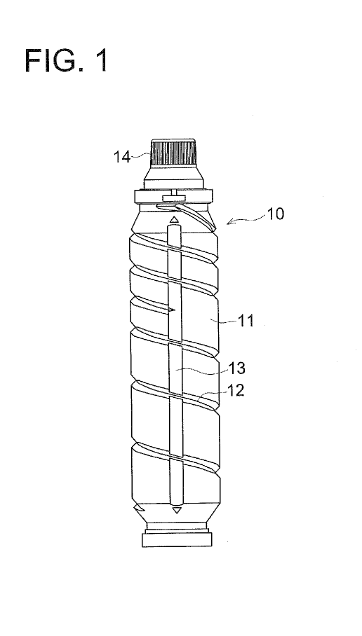

Shape of a toner container is not specifically limited, but the shape as shown in FIG. 1 can be provided. In FIG. 1, toner container 10 possesses helicoidally-shaped groove 12 provided on the outer circumferential surface of toner container main body 11 and straight groove 13 along a longitudinal direction of toner container main body 11, and this straight groove 13 and a protrusion portion provided in a toner container storage space of an image forming apparatus are fit, and installed in the image forming apparatus. Toner container 10 is installed in the toner container storage space in a state where cap 14 provided at the edge of toner container main body 11 is removed.

Examples of the method of manufacturing a toner container employed for a toner product of the present invention include a blow molding method, an injection molding method, an extrusion molding method and so forth. Of these, a blow molding method is specifically preferable. The blow molding method is a molding method by which a plasticized, cylindrically-shaped resin is introduced into a molding die; air is blown into hollow portions in the cylindrically-shaped resin tucked in the die; and the resin is swelled out to closely attach it onto the die and cooled for solidification thereof.

### [Toner]

The toner employed for a toner product of the present invention has an amount of a carboxyl group present on the surface of a toner particle constituting the toner, being 1.0×10⁻⁷-2.5×10⁻⁵ mol/g, and preferably 1.5×10⁻⁶-1.8×10⁻⁵ mol/g. When the toner has an excessive amount of a carboxyl group present on the surface of a toner particle constituting the toner, the toner in the toner container exhibiting moisture permeability specifically at high humidity absorbs an excessive amount of moisture, whereby coagulation resistance is degraded, and image defects and fog caused by toner coagulation tend to be generated in the resulting image. On the other hand, when the toner has a small amount of a carboxyl group present on the surface of a toner particle constituting the toner, electrification of the toner and dispersibility of colorants are deteriorated, whereby the charging amount becomes too low, and fog tends to be generated in the resulting image.

### (Amount of Carboxyl Group)

The amount of a carboxyl group present on the surface of a toner particle constituting the toner can be controlled by adjusting, for example, a composition ratio of an acrylic acid based monomer and a monomer having a carboxyl group such as a methacrylic acid or the like, and the configuration in a polymerization reaction during toner preparation, in the case of a resin formed via addition-polymerization reaction. Further, in the case of a resin formed via a polycondensation reaction, it is controlled by introducing a polyfunctional acid such as, for example, a trimellitic acid or the like to suppress the development of cross-linking reaction, and by adjusting a ratio of an alcohol component to an acid component at the polymerization step.

The amount of a carboxyl group present on the surface of a toner particle constituting the toner is calculated via titration. As to this titration, the toner is dispersed in water, and a titration curve is prepared by changing electrical properties such as electrical conductivity, pH and so forth employing a strongly basic solution as a titration reagent, for example, a sodium hydroxide solution to calculate and determine the amount. Specifically, 5.0 g of toner is charged in a beaker, and 45.0 g of a 1% aqueous sodium dodecyl sulfate solution is added therein to prepare a sample dispersion. The sample dispersion is titrated with a 0.01 N aqueous sodium hydroxide solution employing an electrical conductivity measuring apparatus (ABU91 Autoburett and CDM 80 Conductivity Meter, manufactured by Radiometer Co., Ltd.), and an amount of sodium hydroxide employed to neutralize the carboxyl group is read out from the titration curve. When the amount of an aqueous sodium hydroxide solution is Y mL, the total amount of carboxyl group in the sample dispersion Mt is calculated as shown in the following Formula (1).

Mt=0.01×Y×10⁻³ (mol) Formula (1)

Accordingly, the amount of carboxyl group per unit weight of toner A (mol/g) is calculated from the following Formula (2).

A=Mt/5 (mol/g) Formula (2)

### (Method of Manufacturing Toner)

Examples of the method of manufacturing toner utilized for a toner product of the present invention include a kneading-pulverizing method, a suspension polymerization method, an emulsion polymerization method, an emulsion polymerization coagulation method, an encapsulation method, and other commonly known methods. In consideration of acquisition of a toner having a minimized particle diameter in order to achieve high image quality, the emulsion polymerization coagulation method is preferably usable specifically in view of manufacturing cost and manufacturing stability.

The emulsion polymerization coagulation method is a method by which a dispersion of particles composed of a binder resin produced via an emulsion polymerization method (hereinafter, referred to as “binder resin particles”) is mixed with a dispersion of toner particle constituting components such as other colorant particles, and is slowly coagulated while balancing repulsive force of particle surfaces obtained via pH adjustment and coagulating force obtained via addition of a coagulant formed of an electrolyte, and coagulation is conducted while controlling the average particle diameter and the particle size distribution and shape control is simultaneously conducted via interparticle fusion by applying heat while stirring to manufacture toner particles.

Binder resin particles formed in the case of the emulsion polymerization coagulation method as a method of manufacturing toner may be designed to have a structure of at least two layers composed of binder resins each having a different composition. This structure can be obtained by a method by which a polymerization initiator and a polymerizable monomer are added into a dispersion of the first resin particles prepared via an emulsion polymerization treatment (the first stage polymerization) in accordance with a conventional method to obtain this system via a polymerization treatment (the second stage polymerization).

One example in the case of the emulsion polymerization coagulation method as a method of manufacturing toner will be specifically described, and the method possesses the following processes:

(1) Colorant particle dispersion formation process to obtain colorant particles in which colorant particles and a surfactant, if desired, are contained;

(2) Binder resin particle polymerization process to obtain binder resin particles in which an off-set inhibitor, a charge control agent and so forth, if desired, are contained;

(3) Salting-out/coagulation/fusion process to form toner particles via salting-out, coagulation and fusion of binder resin particles and colorant particles in an aqueous medium;

(4) Filtration/washing process to remove the surfactant and so forth from toner particles by filtrating the toner particles from a dispersion system (aqueous medium) of the toner particles;

(5) Drying process to dry toner particles having been subjected to a washing treatment; and

(6) Process of adding external additives into the toner particle having been subjected to a drying treatment.

Herein, “aqueous medium” means a medium composed of 50-1001 by weight of water and 0-50% by weight of a water-soluble organic solvent. Examples of the water-soluble organic solvent include methanol, ethanol, isopropanol, butanol, acetone, methyl ethyl ketone and tetrahydrofuran, and an alcohol based organic solvent which does not dissolve the resulting resin is preferable.

### (Colorant)

A commonly known inorganic or organic colorant is usable as a colorant constitution a toner. Further, the addition amount of the colorant is 1-30% by weight, based on the total weight of toner, and preferably 2-20% by weight.

### (Binder Resin)

A thermoplastic resin exhibiting sufficient adhesion to a colorant particle is preferably employed as a binder resin constituting a toner, and a solvent-soluble resin is more preferably employed. Further, even a curable resin to form a three-dimensional structure is usable, when the precursor is solvent-soluble. As those other than the above-described conditions, a binder resin constituting the toner, which is selected in consideration of high electrification and fixation with respect to toner, is preferably used. Such the binder resin which is commonly used as the binder resin constituting the toner is usable specifically with not limitation, and specific examples thereof include a styrene based resin, an acrylic resin such as alkyl acrylate or alkyl methacrylate, a styrene-acrylic copolymer resin, a polyester resin, a silicone resin, an olefin resin, an amide resin, an epoxy resin and so forth. Of these, a styrene based resin, an acrylic resin, a styrene-acrylic copolymer resin and a polyester resin exhibiting high transparency and a high sharp-melt property accompanied with low viscosity in meltability are preferably employed in order to improve transparency and color reproduction of superimposed images. A styrene-acrylic copolymer resin is specifically preferable as far as high effectiveness thereof is concerned. These can be used singly or in combination with at least 2 kinds.

Usable examples of polymerizable monomers to obtain the toner binder resin include styrene based monomers such as styrene, methylstyrene, methoxystyrene, butylstyrene, phenylstyrene, chlorstyrene and so forth; (meth)acrylate ester based monomers such as methyl (meth)acrylate, ethyl (meth)acrylate, butyl (meth)acrylate, ethylhexyl (meth)acrylate and so forth; and carboxylic acid based monomers such as an acrylic acid, a methacrylic acid fumaric acid and so forth; and so forth. These can be used singly or in combination with at least 2 kinds.

The binder resin constituting toner preferably has a glass transition temperature (Tg) of 30-50° C. When a glass transition temperature (Tg) of the binder resin is lower than 30° C., the resulting toner can not exhibit sufficient heat resistance, and coagulation of toner-to-toner tends to be generated.

The glass transition temperature of the binder resin is determined employing a differential scanning calorimeter (DSC-7, produced by Perkin Elmer, Inc.) and a thermal analyzer controller (TAC7/DX, produced by Perkin Elmer, Inc.). Specifically, 4.50 mg of a sample is sealed in an aluminum pan (KIT No. 0219-0041), and this is placed in a DSC-7 sample holder. A derivative curve of the resulting curve C_{2nd} is determined to read peal top temperature Tₚ (° C.) on the lowest temperature side at 20° C. or more concerning the derivative curve. An empty aluminum pan is used for the reference measurement. Subsequently, heating-cooling-heating temperature control is conducted under the measuring conditions of a temperature increasing rate of 10° C./min and a temperature decreasing rate of 10° C./min in the measurement temperature range of 0-200° C. to obtain data during the second heating. An intersection point of tangents at temperature Tₚ of C_{2nd} and at a temperature in the range of Tₚ-20° C. is designated as a glass transition temperature. In addition, when temperature Tₚ cannot be clearly read out, an intersection point of an extension of the endothermic side inflection point on the lowest temperature side at 20° C. or more concerning C_{2nd} or the base line before the initial rise of the endothermic peak, and an tangent showing the maximum inclination between the initial rising position of the first endothermic peak and the peak top is designated as the glass transition temperature. Incidentally, when raising temperature during the first heating, the temperature is maintained at 200° C. for one minute.

Further, the binder resin preferably has a softening temperature of 30-130° C., and more preferably has a softening temperature of 90-120° C.

### [Polymerization Initiator]

When the toner is manufactured via an emulsion polymerization coagulation method, as a polymerization initiator to obtain a binder resin, usable is a water-soluble polymerization initiator. Specific examples of the polymerization initiator include persulfate such as potassium persulfate, ammonium persulfate or the like, an azo based compound such as 4,4′-azobis4-cyano valerate, a salt thereof, a 2,2′-azobis(2-amidinopropane) salt, a peroxide compound and so forth.

### (Chain Transfer Agent)

When the toner is manufactured via an emulsion polymerization coagulation method, usable is a commonly known chain transfer agent. The chain transfer agent is not specifically limited, and examples thereof include 2-chloroethanol, mercaptan such as octyl mercaptan, dodecyl mercaptan, t-dodecyl mercaptan or the like, a styrene dimer and so forth.

### (Surfactant)

Examples of surfactants employed when preparing toner by an emulsion polymerization coagulation method include various commonly known ionic and nonionic surfactants, and so forth.

### (Coagulant)

Examples of coagulants employed when preparing toner by an emulsion polymerization coagulation method include alkali metal salts, alkaline earth metal salts and so forth. Examples of the alkali metal constituting the coagulant include lithium, potassium, sodium and so forth, and examples of the alkaline earth metal constituting the coagulant include magnesium, calcium, strontium, barium and so forth. Of these, potassium, sodium, magnesium, calcium and barium are preferable. Examples of a counter ion (namely an anion constituting a salt) of the alkali metal or alkaline earth metal include chloride ion, bromide ion, iodide ion, carbonate ion, sulfate ion and so forth.

### [Off-Set Inhibitor]

An off-set inhibitor may be contained in toner in order to inhibit an off-set phenomenon. Herein, the off-set inhibitor is not specifically limited, and examples thereof include polyethylene wax, oxidization-type polyethylene wax, polypropylene wax, oxidization-type polypropylene wax, carnauba wax, fatty acid ester wax, sasol wax, rice wax, candelilla wax, jojoba wax, bees wax and so forth.

Examples of the method to contain an off-set inhibitor in a toner particle include a method by which a dispersion of off-set inhibitor particles (wax emulsion) is added in the salting-out/coagulation/fusion process to form toner particles, and binder resin particles, colorant particles and off-set inhibitor particles are subjected to salting-out/coagulating/fusing; and a method by which colorant particles and binder resin particles containing a off-set inhibitor are subjected to salting-out/coagulating/fusing in the salting-out/aggregation/fusion process to form toner particles. These methods may be used in combination. The content of an off-set inhibitor in the toner is commonly 1-30 parts by weight, based on 100 parts by weight of a toner particle forming binder resin, and preferably 5-20 parts by weight, based on 100 parts by weight of a toner particle forming binder resin.

### (Charge Control Agent)

A charge control agent may be contained in toner. Examples of the charge control agent include a zinc or aluminum metal complex of a salicylic acid (salicylic acid metal complex), a calixarene based compound, an organic boron compound, a fluorine-containing quaternary ammonium salt compound and so forth. The content of the charge control agent in the toner particle is commonly 0.1-5.0 parts by weight, based on 100 parts by weight of a binder resin.

### (Particle Diameter of Toner Particle)

The toner particles preferably have a volume-based median particle diameter of 3-10 μm, and more preferably have a volume-based median particle diameter of 4-8 μm. When the method of manufacturing toner is an emulsion polymerization coagulation method, this volume-based median particle diameter can be controlled by the concentration of a utilized coagulant (salting-out agent) used, the addition amount of an organic solvent, the fusing time, or the composition of a polymer. When the volume-based median particle diameter falls within the above range, half-tone image quality is improved by increasing the transfer efficiency, and image quality in fine line as well as dot is improved.

The above-described volume-based median particle diameter (D₅₀) of toner particles can be measured and calculated by using an apparatus in which a computer system for data processing is connected to Multisizer 3 (manufactured by Beckman Coulter Inc.). Specifically, after 20 ml of the surfactant solution (surfactant solution in which a neutral detergent containing a surfactant is diluted with pure water by 10 times) is mixed with 0.02 g of toner, the mixture is subjected to an ultrasonic dispersion for one minute to obtain a toner dispersion. This toner dispersion is then poured, using a pipette, in a beaker containing ISOTON II (produced by Beckman Coulter Inc.) placed in a sample stand, until the measured content reaches 5-10% by weight, and a counter is set to 25000 counts to be measured. In addition, a 50 μm aperture diameter of Multisizer 3 is used.

### (External Additive)

In order to improve fluidity, electrification, and a cleaning property, external additives such as a fluidizer, a cleaning aid and so forth may be added into the toner particles to constitute the toner.

Examples of external additive particles include inorganic oxide particles such as silica particles, alumina particles, titanium oxide particles and so forth; inorganic stearic acid compound particles such as aluminum stearate particles, zinc stearate particles and so forth; or inorganic titanic acid compound particles such as strontium titanate, zinc titanate and so forth. These can be used singly or in combination with at least 2 kinds. These inorganic particles are preferably subjected to a surface treatment employing a silane coupling agent, a titanium coupling agent, a higher fatty acid, silicone oil or the like in order to enhance heat-resistant storage stability and environmental stability.

The total addition amount of these various external additives is 0.1-10 parts by weight, based on 100 parts by weight of the toner. In addition, various kinds of external additives may be used in combination.

### (Developer)

The toner employed for a toner product of the present invention can be used as a magnetic or non-magnetic single-component developer, but may be used as a two-component developer by mixing with a carrier. When the toner is used as a two-component developer, magnetic particles made of a conventionally known material such as metal such as iron, ferrite, magnetite or the like, as well as alloy of the forgoing metals each with metal such as aluminum, lead or the like are usable as a carrier, but ferrite particles are specifically preferable. Further, a coat carrier in which the surface of the magnetic particle is coated with a coating agent such as a resin or the like, a binder-type carrier obtained by dispersing magnetic material powder in a binder resin, and so forth are also usable as the carrier. A coating resin to form the coat carrier is not specifically limited, but examples thereof include olefin based resins, styrene based resins, styrene-acrylic resins, acrylic resins, silicone based resins, ester resins, fluorine resins and so forth. Further, those commonly known can be used as the binder resin constituting a binder type carrier specifically with no limitation, and usable examples thereof include styrene-acrylic resins, polyester resins, fluorine resins, phenol resins and so forth. Of these, the coat carrier coated with the styrene-acrylic resin or acrylic resin is preferable in view of electrification and durability.

The carrier preferably has a volume average particle diameter of 20-100 μm, and more preferably has a volume average particle diameter of 25-80 μm in order to acquire high-quality images, and to suppress carrier fog. The volume average particle diameter of the carrier can be measured typically with a laser diffraction type particle size distribution measuring apparatus (HELOS, manufactured by SYMPATEC Co.) equipped with a wet-type homogenizer.

In the case of the foregoing toner product, when the toner is composed of toner particles having a specific amount of carboxyl group, and the toner container is made of a resin containing at least polyethylene terephthalate, the toner possesses an appropriate amount of polar group, resulting basically in an appropriate charging property. Furthermore, since the toner in the toner container is in a state where it possesses a water content matched to the surrounding environmental condition because of the toner container exhibiting appropriate moisture permeability, the toner in the toner product placed under the same environmental condition as in an image forming apparatus brings the same water content as that of the toner present in the image forming apparatus, and the water content difference between a toner in the toner container and another toner present in the image forming apparatus is minimized, whereby a stably sharp charging amount distribution can be obtained, resulting in formation of high-quality images. When the toner container is made of a resin containing at least polyethylene terephthalate, a recycled material becomes possible to be used as a resin constituting the toner container. Incidentally, it is a feature that an image forming apparatus main body is equipped with the toner product of the present invention, and toner stored in a toner container is replenished into a developing device. It is also a feature that the image forming method of the present invention possesses the steps of charging an image carrier to provide an evenly charged potential on the image carrier; exposing the image carrier to light to form an electrostatic latent image on the image carrier with the evenly charged potential, developing the electrostatic latent image with a toner replenished from the toner product of the present invention to visualize a toner image, transferring the toner image onto a transfer material, and fixing the toner image on the transfer material.

### Example

Next, specific examples of the present invention will be described, but the present invention is not limited thereto.

### Toner Preparation Example 1

### Preparation of Resin Particles

### (1) The First Stage Polymerization

A solution in which 8 g of dodecyl sodium sulfate were dissolved in 3 L of deionized water was charged in a 5 L reaction vessel fitted with a stirring device, a temperature sensor, a cooling tube and a nitrogen introducing device, and the liquid temperature was raised to 80° C. while stirring at a stirring speed of 230 rpm under the nitrogen flow. After the raised temperature, a solution in which 10 g of potassium persulfate were dissolved in 200 g of deionized water was added into the system, and the liquid temperature was again set to 80° C. to drop the following monomer mixture solution, spending one hour. Subsequently, the system was heated at 80° C. for 2 hours while stirring, and polymerization was conducted to prepare resin particle [1H].

| | | |
|---|---|---|
| Styrene | 480 | g |
| n-butylacrylate | 250 | g |
| Methacrylic acid | 68 | g |
| n-octyl-3-mercaptopropionate | 16 | g |

### (2) The Second Stage Polymerization

A solution in which 7 g of polyoxyethylene-2-dodecyl ether sodium sulfate were dissolved in 800 mL of deionized water was charged in a 5 L reaction vessel fitted with a stirring device, a temperature sensor, a cooling tube and a nitrogen introducing device. After heating the system at 98° C., a solution in which 260 g of the above-described resin particle [1H] and the following monomer solution were dissolved at 90° C. was added into the system, and mixed while dispersing for one hour employing a mechanical homogenizer (CLEARMIX, manufactured by M-Technique Co., Ltd.) equipped with a circulation path to prepare a dispersion containing emulsified particles (oil droplets).

| | |
|---|---|
| Styrene | 245 g |
| n-butylacrylate | 120 g |
| n-octyl-3-mercaptopropionate | 1.5 g |
| Pentaerythritol tetrabehenic acid ester | 190 g |

Next, a initiator solution in which 6 g of potassium persulfate were dissolved in 200 mL of deionized water was added into this dispersion, and this system was heated and polymerized at 82° C. while stirring for one hour to prepare resin particle [1HM].

### (3) The Third Stage Polymerization

Further, a solution in which 11 g of potassium persulfate were dissolved in 400 g of deionized water was added, and the following monomer mixture solution was dropped, spending one hour. After completion of dropping, the system was heated for 2 hours while stirring and subsequently cooled down to 28° C., and polymerization was conducted to obtain resin particle [1].

| | | |
|---|---|---|
| Styrene | 456 | g |
| n-butylacrylate | 135 | g |
| Methacrylic acid | 9 | g |
| n-octyl-3-mercaptopropionate | 8 | g |

### (Preparation of Colorant Dispersion)

In 1600 mL of deionized water, dissolved were 90 g of sodium dodecylsulfate while stirring. Into the resulting solution, gradually added were 420 g of carbon black (Regal 330R, produced by Cabot Co.) as a colorant, and subsequently dispersed employing a stirrer (CLEARMIX, M•Technique Co., Ltd.) to prepare a colorant particle dispersion (hereinafter, referred to as “colorant dispersion [1]”). The particle diameter of colorant particles of “colorant dispersion [1]”, which was measured employing an electrophoretic light scattering photometer (ELS-800, manufactured by Otsuka Denshi Co., Ltd.), was 110 nm.

### (Coagulation•Fusion Process)

A solution in which 300 g of resin particle [1] in solid content conversion, 1400 g of deionized water, 120 g of colorant dispersion [1] and 3 g of polyoxyethylene-2-dodecylether sodium sulfate were dissolved in 120 mL of deionized water was charged in a 5 L reaction vessel fitted with a stirring device, a temperature sensor, a cooling tube and a nitrogen introducing device, and after the liquid temperature was set to 30° C., and pH was adjusted to 10 via addition of an aqueous 5N sodium hydroxyide solution. Subsequently, an aqueous solution in which 35 g of magnesium chloride were dissolved in 35 mL of deionized water was added into the system at 30° C. for 10 minutes while stirring. After standing for 3 minutes, the system was raised to 90° C. spending 60 minutes to continue the particle growth reaction keeping the temperature at 90° C. In this situation, the particle diameter of associated particles was measured with Multisizer 3, manufactured by Beckman Coulter Inc., and when reaching the desired particle diameter, an aqueous solution in which 150 g of sodium chloride were dissolved in 600 g of deionized water was added to terminate the particle growth. Further, the inter-particle fusion was accelerated until reaching a circularity of 0.965 via measurement employing “EFTA-2100” (manufactured by Sysmex Corp.) by conducting a fusion process at a liquid temperature of 98° C. while stirring. Subsequently, the system was cooled down to 30° C., and pH was adjusted via addition of a hydrochloric acid. Then, the stirring was stopped.

### Washing•Drying Process)

Particles prepared in the coagulation•fusion process were solid/liquid-separated via suction-filtration employing a Nutshe to form a wet cake as toner base particles. This wet cake was washed with deionized water at 35° C. via the foregoing suction-filtration until the filtrated liquid reached 5 μS/cm in electrical conductivity, and then moved to “Flash Jet Dryer” produced by Seishin Enterprise Co., Ltd. and dried until the water content reached 0.5% by weight to prepare toner base particle [1].

### (External Additive Treatment Process)

One part by weight of hydrophobic silica (a number average primary particle diameter of 12 nm) and 0.3 parts by weight of hydrophobic titania (a number average primary particle diameter of 20 nm) were added into 100 parts by weight of above-described toner base particle [1], followed by mixing the system employing a Henschel mixer to prepare toner [1].

### Toner Preparation Example 2-7

Toners [2]-[3] were prepared similarly to toner preparation example 1, except that the charging amount of the monomer mixing liquid in the third stage polymerization was changed as shown in Table 1. Further, values obtained by measuring and determining the amount of carboxyl group present on the surface of the toner particle constituting each of toners [1]-[7] are shown in Table 1.

TABLE 1

| | | n-butyl- | Metha- | n-octyl-3- | Carboxyl group |
|---|---|---|---|---|---|
| Toner | Styrene | acrylate | crylic | mercapto- | on the toner |
| No. | (g) | (g) | acid (g) | propionate (g) | surface (mol/g) |
| Toner | 456 | 135 | 9 | 8 | 1.0 × 10⁻⁷ |
| [1] | | | | | |
| Toner | 453 | 135 | 12 | 8 | 1.6 × 10⁻⁶ |
| [2] | | | | | |
| Toner | 420 | 144 | 36 | 8 | 1.0 × 10⁻⁵ |
| [3] | | | | | |
| Toner | 393 | 153 | 54 | 8 | 1.7 × 10⁻⁵ |
| [4] | | | | | |
| Toner | 372 | 156 | 72 | 8 | 2.0 × 10⁻⁵ |
| [5] | | | | | |
| Toner | 462 | 132 | 6 | 8 | 2.3 × 10⁻⁸ |
| [6] | | | | | |
| Toner | 348 | 162 | 90 | 8 | 2.7 × 10⁻⁵ |
| [7] | | | | | |

### Developer Preparation Examples 1-7

A ferrite carrier having a volume average particle diameter of 60 μm, which is obtained by coating an acrylic resin was mixed with respect to each of toners [1]-[7] employing a V-type mixer so as to give a toner concentration of 4%, and toner developers [1]-[7] were prepared.

### Toner Container Preparation Examples 1-10

In accordance with resin compositions and composition ratios shown in Table 2, each of toner containers [1]-[10] as shown in FIG. 1 were prepared by a blow molding method. In addition, The wall thickness of each of toner containers [1]-[10] is shown in Table 2.

TABLE 2

| | PET | Mixed resin | | Wall thickness |
|---|---|---|---|---|
| | (parts by | | Parts by | of toner |
| | weight) | Kinds | weight | container (mm) |
| Toner | 50 | Polypropylene | 50 | 1.30 |
| container | | | | |
| [1] | | | | |
| Toner | 80 | polycarbonate | 20 | 1.30 |
| container | | | | |
| [2] | | | | |
| Toner | 100 | — | — | 1.30 |
| container | | | | |
| [3] | | | | |
| Toner | 100 | — | — | 0.15 |
| container | | | | |
| [4] | | | | |
| Toner | 100 | — | — | 0.20 |
| container | | | | |
| [5] | | | | |
| Toner | 100 | — | — | 1.95 |
| container | | | | |
| [6] | | | | |
| Toner | 40 | Polypropylene | 60 | 1.95 |
| container | | | | |
| [7] | | | | |
| Toner | 100 | — | — | 0.10 |
| container | | | | |
| [8] | | | | |
| Toner | 40 | Polypropylene | 60 | 2.10 |
| container | | | | |
| [9] | | | | |
| Toner | 0 | Polyethylene | 100 | 1.95 |
| container | | | | |
| [10] | | | | |

PET having an Mw of 44,000 and an Mn of 24,000 is used.

### Examples 1-13 and Comparative Examples 1-3

As to the toner product obtained by filling any one of toners [1]-[7] acquired as described above in any one of toner containers [1]-[10] with the combination shown in Table 3, the following evaluations were conducted. In addition, the filling environment is charged in accordance with an objective of the evaluation. Further, an image forming apparatus “bizuhub 500”, manufactured by Konica Minolta Business Technologies, Inc. is employed, and the developer in the image forming apparatus was prepared by using the corresponding toners [1]—[7] each.

### (1) Coagulation

After the toner and the toner container were left standing at a temperature of 20° C. and a relative humidity of 50% for 12 hours, the toner was filled in the toner container with the combination shown in Table 3. This toner product was left standing at a temperature of 40° C. and a relative humidity of 85% for 1000 hours, and subsequently left standing at a temperature of 20° C. and a relative humidity of 50% for 12 hours. Then, the toner product was installed in “bizuhub 500” which had been placed at a temperature of 20° C. and a relative humidity of 50% for at least 12 hours, and 5000 print sheets of an image having a blackened surface area of 5% were continuously output. Among output images, as to an image of the 1^{st} print sheet, an image of the 1000^{th} print sheet, an image of the 2000^{th} print sheet, an image of the 3000^{th} print sheet, an image of the 4000^{th} print sheet and an image of the 5000^{th} print sheet, whether or not image defects in the form of black spots were observed was visually checked, and evaluated as described below.

A: No image defect in the form of black spots is observed.

B: Image defects in the form of black spots are observed, but no practical problem is seen.

C: Coagulation resistance is insufficient when image defects in the form of black spots having a longer diameter of at least 1 mm are observed.

### (2) Image Evaluation at HH (High Temperature and High Humidity)

After the toner and the toner container were left standing at a temperature of 10° C. and a relative humidity of 20% for 12 hours, the toner was filled in the toner container with the combination shown in Table 3 to prepare the toner product. After this toner product was left standing at a temperature of 30° C. and a relative humidity of 80% for at least 12 hours, the toner product was filled in “bizhub 500” left standing at the same environment for at least 12 hours, and white solid images were output immediately after 20 print sheets of black solid images in A4 size were continuously output. Image density of the last black solid image having been continuously output and fog density of white solid image were measured by an after-mentioned method.

### (3) Image Evaluation at LL (Low Temperature and Low Humidity)

After the toner and the toner container were left standing at a temperature of 30° C. and a relative humidity of 80% for 12 hours, the toner was filled in the toner container with the combination shown in Table 3 to prepare the toner product. After this toner product was left standing at a temperature of 10° C. and a relative humidity of 20% for at least 12 hours, the toner product was filled in “bizhub 500” left standing at the same environment for at least 12 hours, and white solid images were output immediately after 20 print sheets of black solid images in A4 size were continuously output. Image density of the last black solid image having been continuously output and fog density of white solid image were measured by an after-mentioned method.

### [Measuring Method of Image Density]

In the measuring method of image density, the absolute image density of evaluation paper which does not pass through an image forming apparatus (white paper) was measured evenly at 12 points employing a reflective densitometer (RD-918, manufactured by Macbeth Co., Ltd.) and a mean value thereof to be determined was specified as white paper density. Next, the absolute density of the output black solid image was similarly measured at 12 points to determine a mean value thereof, and the value obtained via subtraction of the white paper density from this mean value was evaluated as image density. In addition, an image density of at least 1.3 is set to be accepted.

### [Measuring Method of Fog Density]

In the measuring method of fog density, the absolute image density of not printed evaluation paper (white paper) was measured evenly at 12 points employing a reflective densitometer (RD-918, manufactured by Macbeth Co., Ltd.) and a mean value thereof to be determined was specified as white paper density. Next, the absolute density of the output white solid image was similarly measured at 12 points to determine a mean value thereof, and the value obtained via subtraction of the white paper density from this mean value was evaluated as fog density. In addition, a fog density of 0.010 or less is set to be accepted.

TABLE 3

| | | | | HH | | LL | |
|---|---|---|---|---|---|---|---|
| | Toner | | Coagu- | Image | | Image | |
| | container | Toner | lation | density | Fog | density | Fog |
| Ex. 1 | Toner | Toner | A | 1.31 | 0.003 | 1.30 | 0.003 |
| | container | [1] | | | | | |
| | [1] | | | | | | |
| Ex. 2 | Toner | Toner | A | 1.35 | 0.002 | 1.36 | 0.002 |
| | container | [2] | | | | | |
| | [1] | | | | | | |
| Ex. 3 | Toner | Toner | A | 1.36 | 0.002 | 1.36 | 0.002 |
| | container | [3] | | | | | |
| | [2] | | | | | | |
| EX. 4 | Toner | Toner | A | 1.38 | 0.002 | 1.37 | 0.002 |
| | container | [4] | | | | | |
| | [2] | | | | | | |
| Ex. 5 | Toner | Toner | A | 1.41 | 0.001 | 1.39 | 0.001 |
| | container | [5] | | | | | |
| | [3] | | | | | | |
| Ex. 6 | Toner | Toner | A | 1.40 | 0.000 | 1.39 | 0.000 |
| | container | [3] | | | | | |
| | [3] | | | | | | |
| Ex. 7 | Toner | Toner | A | 1.34 | 0.003 | 1.33 | 0.002 |
| | container | [1] | | | | | |
| | [3] | | | | | | |
| Ex. 8 | Toner | Toner | A | 1.42 | 0.004 | 1.40 | 0.003 |
| | container | [5] | | | | | |
| | [4] | | | | | | |
| Ex. 9 | Toner | Toner | A | 1.41 | 0.002 | 1.40 | 0.001 |
| | container | [3] | | | | | |
| | [5] | | | | | | |
| Ex. 10 | Toner | Toner | A | 1.31 | 0.002 | 1.32 | 0.004 |
| | container | [1] | | | | | |
| | [6] | | | | | | |
| Ex. 11 | Toner | Toner | A | 1.37 | 0.005 | 1.37 | 0.006 |
| | container | [5] | | | | | |
| | [7] | | | | | | |
| Ex. 12 | Toner | Toner | B | 1.42 | 0.004 | 1.40 | 0.002 |
| | container | [5] | | | | | |
| | [8] | | | | | | |
| Ex. 13 | Toner | Toner | A | 1.36 | 0.007 | 1.35 | 0.008 |
| | container | [5] | | | | | |
| | [9] | | | | | | |
| Comp. 1 | Toner | Toner | A | 1.25 | 0.008 | 1.35 | 0.015 |
| | container | [5] | | | | | |
| | [10] | | | | | | |
| Comp. 2 | Toner | Toner | A | 1.22 | 0.020 | 1.28 | 0.018 |
| | container | [6] | | | | | |
| | [5] | | | | | | |
| Comp. 3 | Toner | Toner | C | 1.42 | 0.015 | 1.37 | 0.012 |
| | container | [7] | | | | | |
| | [5] | | | | | | |

Ex.: Example
Comp.: Comparative example

As described above, it was confirmed that high quality images exhibiting lowering in image density together with no generation of fog were possible to be reliably formed in Examples 1-13 of the present invention.

### EFFECT OF THE INVENTION

In the case of the toner product of the present invention, when the toner is composed of toner particles having a specific amount of carboxyl group, and the toner container is made of a resin containing at least polyethylene terephthalate, the toner possesses an appropriate amount of polar group, resulting basically in an appropriate charging property. Furthermore, since the toner in the toner container is in a state where it possesses a water content matched to the surrounding environmental condition because of the toner container exhibiting appropriate moisture permeability, the toner in the toner product placed under the same environmental condition as in an image forming apparatus brings the same water content as that of the toner present in the image forming apparatus, and the water content difference between a toner in the toner container and another toner present in the image forming apparatus is minimized, whereby a stably sharp charging amount distribution can be obtained, resulting in formation of high-quality images. The difference between the water content of a toner in a toner container and the water content of another toner present in an image forming apparatus is minimized by using the above-described toner product, resulting in formation of high quality images because of stable acquisition of a sharp charging amount distribution.

Further, when a toner container in the toner product of the present invention is made of a resin containing at least polyethylene terephthalate, a recycled material becomes possible to be used as a resin constituting the toner container.

What is claimed is:

1. A toner product in which a toner is stored in a toner container,
wherein the toner comprises a toner particle having an amount of a carboxyl group present on a surface of the toner particle, being 1.0×10⁻⁷-2.5×10⁻⁵ mol/g, and the toner container comprises a resin comprising polyethylene terephthalate, the amount of the carboxyl group determined via titration employing a strongly basic solution as a titration reagent after dispersing the toner in water.

2. The toner product of claim 1,
wherein the toner container has a wall thickness of 0.15-2.0 mm.

3. An image forming method comprising the steps of:
(a) charging an image carrier to provide an evenly charged potential on the image carrier,
(b) exposing the image carrier to light to form an electrostatic latent image on the image carrier with the evenly charged potential,
(c) developing the electrostatic latent image with a toner replenished from the toner product of claim 1 to visualize a toner image,
(d) transferring the toner image onto a transfer material, and
(e) fixing the toner image on the transfer material.

4. An image forming method comprising the steps of:
(a) charging an image carrier to provide an evenly charged potential on the image carrier,
(b) exposing the image carrier to light to form an electrostatic latent image on the image carrier with the evenly charged potential,
(c) developing the electrostatic latent image with a toner replenished from the toner product of claim 2 to visualize a toner image,
(d) transferring the toner image onto a transfer material, and
(e) fixing the toner image on the transfer material.

5. The toner product of claim 1,
wherein the amount of the carboxyl group is 1.5×10⁻⁶-1.8×10⁻⁵ mol/g.

6. The toner product of claim 1,
wherein the resin has a polyethylene terephthalate content of 50% by weight or more.

7. The toner product of claim 2,
wherein the toner container has a wall thickness of 0.2-1.35 mm.
